(19) United States
(12) Patent Application Publication
(10) Pub. No.: US 2002/0030598 A1
(43) Pub. Date: Mar. 14, 2002

(54) Radio frequency label for multiwell plates or slides

(76) Inventors: Scott A. Dombrowski, Kennebunkport, ME (US); Martin J. Popoloski, Woburn, MA (US); Paul M. Szlosek, Kennebunk, ME (US); Alan L. Tibbetts, Limington, ME (US)

Correspondence Address: Corning Incorporated, SP-FR-02-12, Corning, NY, 14831, US

(21) Appl. No.: 09/785,880

(22) Filed: Feb. 16, 2001

Related U.S. Application Data
(60) Provisional application No. 60/183,224, filed on Feb. 17, 2000.

(51) Int. Cl. G08B 13/14

(52) U.S. Cl. 340/572.1; 340/540

(57) ABSTRACT

A multiwell plate or other substrate for use in performing biological and chemical analysis, the contents of which are identifiable by means of a radio frequency labeling system.

This application claims the benefit of US provisional patent application No. 60/183.224 Filed on Feb. 17. 2000 entitled RF IDENTIFICATION FOR MICROTITER PLATES OR SLIDES.

### FIELD OF INVENTION

The invention relates to radio frequency identification labels for laboratory ware and, more specifically, to radio frequency labels for multiwell test plates and nucleic acid microarray slides.

### BACKGROUND OF INVENTION

For many years, multiwell laboratory plates have been manufactured in configurations ranging from 24 to 96 to 384 wells, and beyond. The wells of multiwell plates are typically used as reaction vessels for performing various tests, growing tissue cultures, screening drugs, or performing analytical and diagnostic functions. Automation of analyses in the drug industry has fueled new methods of drug discovery: high throughput screening and combinatorial chemistry. By using these techniques pools of thousands of compounds having slight chemical variations are screened en masse. Only a small fraction of drug candidates show promise, but by testing thousands or even millions of compounds, the likelihood of stumbling on a compound with promising biological activity is increased.

High density arrays are new tools used by drug researchers and geneticists which provide information on the expression of genes from particular cells. A high density array typically comprises between 5.000 and 50.000 probes in the form of DNA strands, each of known and different sequence, arranged in a determined pattern on a substrate. The substrate may be any size but typically takes the form of a 1×3 inch glass microscope slide. The arrays are used to determine whether target sequences interact or hybridize with any of the probes on the array. After exposing the array to target sequences under selected test conditions, scanning devices can examine each location on the array and determine whether a target molecule has hybridized with the probe at that location. DNA arrays can be used to study which genes are “turned on” or up regulated and which genes are “turn off” or down regulated. So for example, a researcher can compare a normal colon cell with a malignant colon cell and thereby determine which genes are being expressed or not expressed only in the aberrant cell. The regulation of these genes serves as key targets for drug therapy.

A means linking the physical multiwell plate and its contents with a corresponding database which stores information about the contents of each specific well, is required. Likewise, a means for linking the physical microarray slide and the vast amount of genetic information on it, to a corresponding database which stores information about each of thousands of sequences contained on the slide, is required. Typically, this has been accomplished by the attachment of a bar code label to the array slide or to the microplate. Unfortunately, the bar codes are often attached with adhesives which tend to bleed into the wells or across the slide. This bleeding has negetively effected the biological and chemical activity of the substrate surfaces in both array slides and multiwell plates. Further, should certain conditions change it is likely that the bar code label would need to be removed and subsequently replaced with a new bar code label identifying the updated conditions. Finally, there are limitations to the amount of information that can be stored in a bar code label affixed to the end of an industry standard microplate or an array slide. For example, the number of characters allowed in a linear bar code is approximately between 10 and 20 when the label is affixed to the short skirt portion of a multiwell plate.

### SUMMARY OF INVENTION

The present invention provides a radio frequency labeling system affixed to or integrally molded with a multiwell plate or a microarray substrate. The radio frequency label may eliminate concerns about sample contamination from adhesives, allows for input of additional information or rewriting of data, enables storage of larger amounts of data, survives extremes in temperature and conditions, may be read without physical contact with a scanning device, provides security against theft, and may be integrally molded within the substrate or plate.

### BRIEF DESCRIPTION OF THE FIGURES

FIG. 1. is a substrate having a radio frequency label attached thereto.

FIG. 2 is a plan view of a transponder circuit and antenna portion of a radio frequency label system.

FIG. 3. is a multiwell plate having a radio frequency label attached to its surface.

FIG. 4 is a multiwell plate having a radio frequency label embedded within its structure.

### DETAILED DESCRIPTION OF THE INVENTION

The purpose of this invention is to provide the ability to read and write data, to and from a multiwell plate or array slide. The interface of this identification technology with the plate or slide provides a means for storing information within the individual product, with the ability to be updated or revised at any time.

In general, a standard radio frequency identification system consists of a thin flexible substrate bearing a transponder antenna and a transponder circuit chip all encased in a suitable protective covering material. Transponders such as the type generally described in U.S. Pat. No. 4.730.188 to Milheiser may be employed by the present invention. Transponders of this type are made by Gempius International SA, Luxembourg, Germany) and sold under the tradename Gemwave. Such devices have reading ranges in the order of eight to twelve inches.

This type of magnetically coupled identification system includes a reader/exciter that transmits a radio frequency interrogation signal at a frequency which may be, for example, in the order of 13.5 MHz, although other frequencies are available. The transmitted interrogation signal produces a magnetic flux field that is magnetically coupled to the transponder antenna to energize it and provide power for the transponder identification and data readout circuitry. The latter carries no battery or other source of stored power. Upon energization of its antenna, the transponder identification circuitry assembles an identification code or information signal and other data that are stored in the memory of the transponder. The assembled information signal may contain identification code or information signal related to the individual wells of the multiwell plate, for example. This information signal is fed to the transponder antenna to cause it to transmit return of information signal that is received by the reader/exciter, where it is detected and employed for selected use. Other transponders, including various combinations of antenna and chip, have also been mounted on rigid printed circuit boards, and may also be suitable for impregnation or attachment to a plate or slide.

Three different types of radio frequency tags exist and are commercially available: a “read only” (factory programmed tag). a “write once read many”, and a “read/write” format. The semiconductor technologies employed in these formats are ROM (read only memory), RAM (random access memory) and EEPROM (electronic erasable programmable read only memory) respectfully. In a preferred embodiment, a multiwell plate is labeled with a radio frequency tag of the read/write format. With such a format, altered or additional information may be added to the tag at any time, eliminating the need to physically remove and change labels. Radio frequency identification of multiwell plates and/or slides enables the automation of processes and high-speed data transactions. This in turn facilitates higher-level automation as required by many high throughput screening assays. For example, the number of characters allowed in a linear barcode are limited to between 10 and 20 characters. In comparison, Radio frequency identification labels enable the storage of up to 250 characters presently, with the promise of higher storage capacity in the future.

Further, radio frequency identification labels are able to effectively withstand temperature extremes and are mechanically durable. Depending on the well contents, storage of multiwell plates may require lengthy exposure to temperatures between 40 to-70 degrees C. In this environment, plates often become covered with frost, making the application of replacement or additional labels difficult and time consuming. Radio frequency identification tags on multiwell plates or slides enable the information to be read or added to without having to make any physical contact with the plate or label. The information transfer may occur through ice or liquid and does not require a line of sight to be read. Several tags may also be read at once, providing simultaneous identifications, while avoiding data collision.

Additionally, radio frequency identification tags enable the gathering, display and modification of variable information specific to a particular multiwell plate or slide, and may serve multiple needs in a given application. For example, a user may track a plate's storage times and temperatures over the life of the plate. Alternatively, a plate's tag may keep information on well volumes over time as well as the identity of who has worked with a particular plate over it's life. This information may be easily transferred to a remote computer and interpreted for display through the appropriate software.

Radio frequency identification systems for multiwell plates or slides may be tailored to fit on paper as an adhesive label, in polymer, ceramic or other substrates. The flexible form enables customization to the limited marking and labeling area of a microplate or slide. Elaborate ultra-thin semiconductor technology enables lamination to a paper or plastic label which in turn enables the tags to be automatically applied to multiwell plates or other laboratory ware.

The compounds and materials handled in multiwell plates and other associated laboratory ware may be very costly or proprietary. An additional advantage of the use of radio frequency identification tags is security against theft of information or unauthorized removal and transport of the multiwell plate.

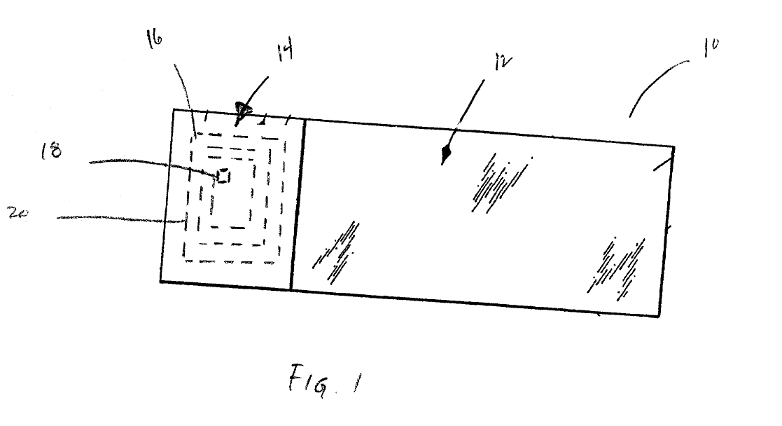

FIG. 1 is a substrate 10 of the present invention. The substrate has an active area 12 upon which biological or chemical species may be immobilized or otherwise attached for experimental purposes in an array or other format. A label attachment region 14 occupies a small area on one side of the substrate 10. An adhesive label 16 having an upper and lower surface is attached to the label attachment region. A radio frequency transponder chip 18 and transponder antenna 20 are located between the substrate surface and the lower surface of the label 16, all encased in a suitable protective covering material. Although not shown, additional information including bar code labeling or printed alphanumeric messages may occupy the upper surface of the adhesive label. Alternatively, the label upper surface may remain without indicia (as shown in FIG. 1). allowing a user to mark it with a pen, for example. Preferably, the upper surface of the label is opaque white, but may be any color.

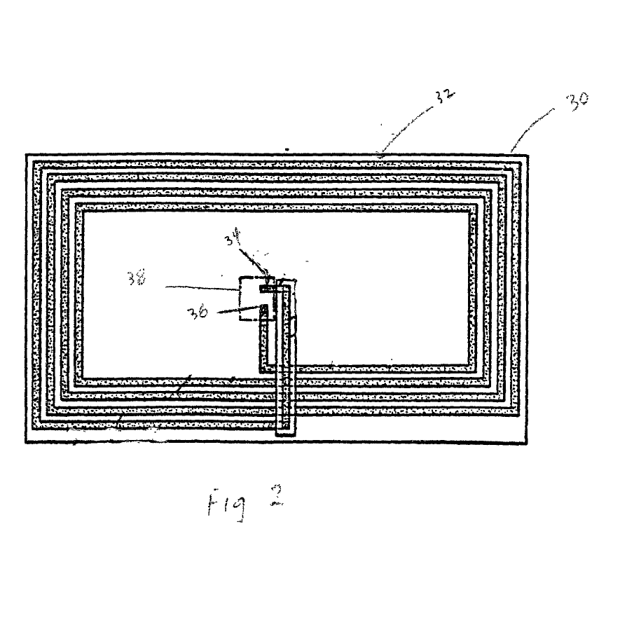

FIG. 2 shows an exemplary design of a radio frequency system arrangement. The transponder is formed on a thin flexible strip of electrically non-conductive material, such as a polyester strip. A plurality of turns 30 of electrically conductive material are formed as by the conventional printed circuit techniques including electroforming, standard etching or screen printing processes on the dielectric polyester substrate. The antenna includes electrical contact antenna pads 34, 36 that connect to a double metal layer integrated circuit chip 38 containing all the transponder circuitry. A layer of dielectric then covers the circuitry. The transponder unit may then be attached to a label as described above, or encased in a molded product.

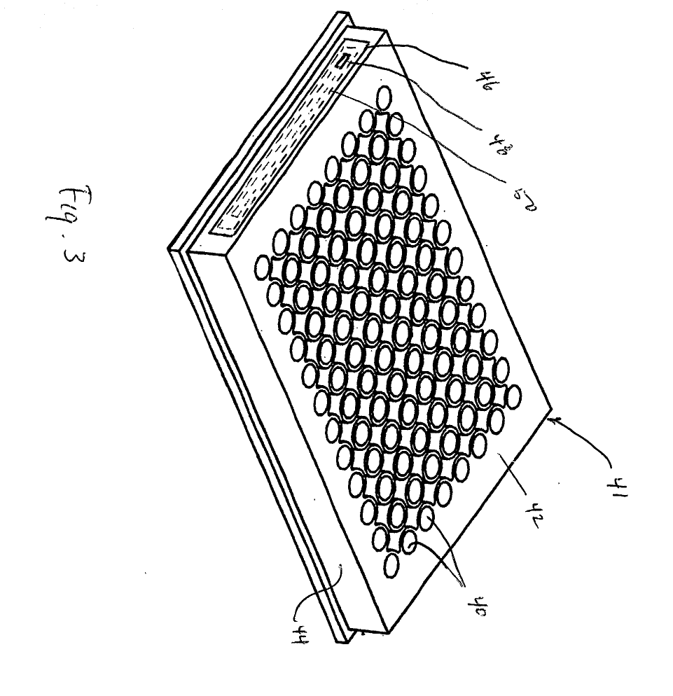

FIG. 3 shows a multiwell plate 41 of the present invention. The plate comprises a plurality of wells arranged in mutually perpendicular rows and columns. The wells descend from a top surface 42. A peripheral skirt 44 surrounds the plate 41. In order to accommodate standard automated equipment, the plate footprint preferably conforms approximately to industry standards (12.77 cm ±0.25 cm in length and 8.55 cm ±0.25 cm in width). An adhesive radio frequency tag 46 is attached to the plate skirt on the plate's shorter side. The transponder circuit 48 and transponder antenna 50 are located under the top surface of the label 46. A tag (not shown) fitted for the longer side of the plate skirt 44 may also be employed. As with the slide embodiment, additional information including bar code labeling or printed alphanumeric messages may occupy the upper surface of the adhesive label. Alternatively, the label upper surface may remain without indicia (as shown in FIG. 3), allowing a user to mark it with a pen, for example. Preferably, the upper surface of the label is opaque white, but may be any color. It should be noted that examples of locations for the tags are presented the tags may be properly applied to any suitable area of the plate.

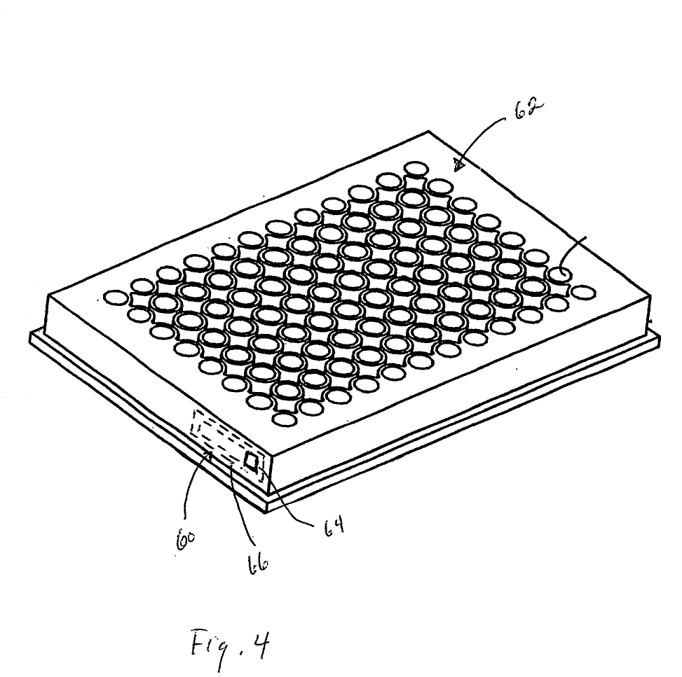

FIG. 4 is a multiwell plate of the current invention in which a transponder unit 60 is embedded within the plate 62 itself. A transponder chip 64 and transponder antenna 66 are attached to a flexible or rigid substrate. The substrate is inserted into a mold in the desired location. For example, the radio frequency tag unit may be placed in a pocket capturing the outer edges of the transponder chip and allowing the major portion of the chip to sit free in the cavity of the tool. The plate is then molded around the transponder unit by standard insert molding techniques such that the tag is entirely encased and integral with the plastic material making up the plate. Upon injection of the polymer, the portion of the unit that is not touching the metal core or cavity is encapsulated within the plate. Advantages of integrally molding the transponder unit within the plate (or slide) are that no adhesives are necessary for attachment thereby eliminating any contamination issues, the unit cannot be removed, and the unit is safe from damage.

Description of Working Prototypes

Two types of working prototypes were produced: both were in the read/write format. The first was an ARIO 40 (Gempius International SA, Luxembourg, Germany), 2-KB 0.54″×0.53″ tag with the memory capability of 250 characters. It was manually inserted underneath a 2.5″×1.0″ die cut adhesive label approximately 0.125″ from the trailing edge of the label. Additionally, a thermal transfer-printing technique was employed on the upper surface of the label in order to print a 12 character linear barcode approximately 1.67″ wide, along with a 12 character alphanumeric portion under the barcode. Fifteen of these labels were fixed to multiwell plates. It is conceivable that both the label production as well as the label application to a substrate could be automated with standard automation equipment.

Additional multiwell plates were fitted with an 8.9 mm ARIO tag (8.9 mm diameter tag) (Gempius International SA, Luxembourg, Germany), which was mechanically attached to an inside face of the multiwell plate skirt with an adhesive. This is the smallest tag commercially available enabling 200-225 characters put into memory. These prototypes were not labeled with other indicia such as bar codes. Both sets of prototypes were identically programmed and used with the prototype software that was written for the demonstration.

Results

Two types of readers were used in the prototype system, a Gemwave Medio F-P11 (Gempius International SA, Luxembourg, Germany) fixed reader was used for proximity identification and Gem Wave H-P12 hand held reader also was used for proximity identification.

The F-P11 is connected to a 9-inch antenna. The casing was designed for industrial environments and may either be connected to a PC or used as a stand-alone device. This fixed type reader lends itself to tabletop and conveyor reading or other applications which enable physical access between tag and reader.

The H-P12 is a lightweight “gun type” reader connected to a 50-ohm antenna allowing for portability and simple trigger activated reading. This reader may be used with a handheld computer, which stores data and later downloads to a computer network for maximum flexibility, or it may be hooked directly into a computer for fixed, on-site applications.

The prototype runs were successful on all samples tested. In each instance, data to be stored by the plates were input, added to and changed. The plates were read and data was analyzed using a software system developed by Computype (Tuscon. Ariz.). In all instances, data were retrieved efficiently.

1. A substrate used for the immobilization of biomolecules comprising:
(a) a substantially flat slide having an upper and lower surface;
(b) a radio frequency labeling indicia either bonded to the upper or lower surface, or integral with said slide.

2. The substrate of claim 1 further comprising a biomolecular immobilizing film coating said upper surface of said slide.

3. The substrate of claim 2 further comprising a biomolecule attached to said upper surface of said substrate.

4. The substrate of claim 2 wherein said biomolecule is a DNA probe.

5. The substrate of claim 1 further comprising an array of biomolecules attached to the upper surface of said slide.

6. A multiwell plate comprising:
(a) a peripheral skirt;
(b) a top portion;
(c) a matrix of wells, said wells having bottoms, sidewalls and open tops; and,
(d) a radio frequency labeling indicia attached to said plate or integrally molded therein.

7. A multiwell filter plate comprising:
(a) a peripheral skirt;
(b) a top portion;
(c) a matrix of wells, said wells having filter bottoms, sidewalls and open tops; and,
(d) a radio frequency labeling indicia attached to said plate or integrally molded therein.

8. A laboratory product selected from the group consisting of:
PCR plate, block, cluster tube, rack, flask, roller bottle, tube, vial, and dish; and
whereby a radio frequency labeling indicia is either bonded to a surface of the laboratory product or embedded within a surface thereof.
